(19) United States
(12) Patent Application Publication
(10) Pub. No.: US 2011/0232408 A1
(43) Pub. Date: Sep. 29, 2011

(54) DEVICE AND METHOD FOR THE CONTROL OF AN AUTOMATIC TRANSMISSION AND OF A MOTOR VEHICLE

(75) Inventor: Klaus-Dieter Rampf, Tuebingen (DE)

(73) Assignee: GM GLOBAL TECHNOLOGY OPERATIONS LLC, Detroit, MI (US)

(21) Appl. No.: 13/131,677

(22) PCT Filed: Nov. 4, 2009
(86) PCT No.: PCT/EP09/07890

§ 371 Date: May 27, 2011

(30) Foreign Application Priority Data
Nov. 27, 2008 (DE) 102008059417.2

(51) Int. Cl. F16H 59/02

(52) U.S. Cl. 74/473.3

(57) ABSTRACT

A device and a method are provided for the actuation and for the control of an automatic transmission of a motor vehicle with at least one actuation element arranged on a steering device of the vehicle, which is designed for the manual selecting or activating of an operating state of the vehicle and/or of its transmission, wherein the at least one actuation element is optionally transferred into a rest position or into an actuation position and wherein the actuation element can be exclusively actuated in the actuation position for selecting or activating the transmission or vehicle function, while in its rest position it stays in a position that is not visible to the driver.

### CROSS-REFERENCE TO RELATED APPLICATION

This application is a U.S. National-Stage entry under 35 U.S.C. §371 based on International Application No. PCT/EP2009/007890, filed Nov. 4, 2009, which was published under PCT Article 21(2) and which claims priority to German Application No. 102008059417.2, filed Nov. 27, 2008, which are all hereby incorporated in their entirety by reference.

### TECHNICAL FIELD

The present invention relates to a device and a method for the actuation and control of an automatic transmission of a motor vehicle, wherein on a steering device of the motor vehicle at least one actuation element for the manual selection or controlling of the operating mode of the vehicle and/or its transmission is arranged.

### BACKGROUND

An automatic transmission of a motor vehicle largely selects a shifting mode of the transmission independently of the vehicle parameters such as speed and the control commands predetermined by the driver that prevail in each case. In such a conventional automatic mode the respective automatic driving program of the transmission determines the respective gear to be engaged or the transmission ratio with which the engine rotational speed is transmitted to the drive wheels of the motor vehicle in each case.

A multiplicity of automatic transmissions additionally makes available an automated manual actuation mode. Here, the driver of the motor vehicle can manually shift into a next higher or lower gear and thus at least at times disable the function of the automatic transmission through its manual presetting.

To technically implement an automatic transmission with manual actuation a shift selector lever can for example be provided which in a first shifting gate can be moved into different positions, preferentially in the positions P, R, N and D as with a conventionally automatic transmission. In addition it can be provided to configure the shift selector lever moveable along a second shifting gate, more preferably in a transverse gate, in which the shift selector lever can assume positions “plus” or “minus” in order to be able to make available a corresponding upshifting or downshifting in the manual shifting mode.

In the prior art, actuation devices for the manual actuation of the automatic transmission are furthermore provided which are arranged in the region of the steering wheel. These can for example be designed as separate switches for upshifting or downshifting of the transmission gears.

Thus, DE 101 57 393 A1 for example discloses a method and a device for the control of the shifting of an automatic transmission with a manual actuation device, which is arranged in the region of the steering wheel, so that the driver for example for changing a specific driving program, for example from the comfort driving program into a sports driving program or into an economy driving program no longer needs to take the hands off the steering wheel. Accordingly it is provided to arrange an actuation device in the region of the steering wheel designed in the form of switches, so that in a manual shifting mode appropriate upshifting or downshifting of the transmission can be effected by means of these switches.

Here, the manual shifting mode can be activated for instance via the shift selector lever arranged in the region of the shifting console or directly via the switches arranged in the region of the steering, wherein the latter through actuation over an extended period activate the manual shifting mode. Here, it is additionally conceivable to arrange a further additional switch in the region of the steering wheel for changing-over from automatic mode to manual mode and vice versa.

Although the arrangement of switches directly on the steering wheel appears advantageous in principle, such an arrangement in practice proves to be disadvantageous at times, since inadvertent operating errors of the switches or shifting rockers occur quite frequently as experience shows. In particular so when traversing larger steering angles for example when parking the motor vehicle.

### SUMMARY

Therefore at least one object to make available a device described at the outset or a corresponding method for the control and actuation of an automatic transmission of a motor vehicle, with which possible operating errors are better avoided and which contributes to a particularly attractive and esthetic design of a steering device.

The device according to an embodiment of the invention is designed for the actuation and/or control of an automatic transmission of a motor vehicle and additionally comprises an actuation element arranged on a steering device of the motor vehicle. This actuation element is designed for the manual selection or control of an operating state of the vehicle and/or its transmission. The at least one actuation element in this case is more preferably provided to select or activate a next higher or next lower gear or a corresponding ratio of the transmission through appropriate selection.

The device according to an embodiment of the invention is additionally characterized in that the at least one actuation element can be optionally transferred into a rest position or into an actuation position. Here, the actuation element itself is moveably, more preferably pivotably arranged on the steering device of the motor vehicle. The rest position and the actuation position are additionally characterized in that the actuation element can be actuated exclusively in the actuation position for selecting and/or controlling a transmission and/or vehicle function.

By contrast, in the rest position the actuation element is located in such a position which prevents actuation, particularly inadvertent actuation of the actuation element. The actuation element cannot be actuated in its rest position so that in this position a possible operating error of the actuation element can be entirely excluded.

Here it is additionally provided that the actuation element on reaching its rest position assumes such a position that it is not visually perceptible by the driver of the motor vehicle or the other occupants. Here it can be additionally provided that the actuation element on assuming its rest position can also no longer be haptically sensed, in other words is no longer available to be haptically sensed.

Through the optional transfer of the at least one actuation element into a rest position that is invisible and/or cannot be haptically sensed by the vehicle occupants but at least by the driver of the motor vehicle the entire steering device changes its visual appearance. In this manner it is suggested to the driver that the automatic transmission, consequently the vehicle, is exclusively operated in the purely automatic driving mode.

If however the at least one actuation element is transferred into its actuation position it is actuatable by the driver of the vehicle in the intended manner so that depending on the wish of the driver an appropriate gear or a certain operating mode of the transmission can be selected as required.

According to a first embodiment of the invention it is provided that the transfer of the actuation element into its rest position and/or into its actuation position takes place as a function of a selected operating mode of the motor vehicle or of the transmission. As operating modes of the automatic transmission or of the motor vehicle, different driving programs such as for example a comfort program, a dynamic or sportive driving program or an economy driving program and the like are provided for example.

The driving programs or the operating modes of the motor vehicle or of the transmission can be selected via a separate actuation device which can be implemented on or in the vicinity of the steering device or on or in the shift selector lever, which is typically arranged in the centre console of the motor vehicle.

With the selection of a certain operating mode it is not only possible to change the matching or the shifting behavior of the automatic transmission. It is additionally conceivable that by selecting a corresponding operating mode the chassis and the spring suspension of the motor vehicle are also subjected to a correspondingly changed coordination.

If the driver for example starting out from a comfort mode selects the dynamic mode or the sports mode of the motor vehicle this can by means of this be accompanied by a corresponding matching of the chassis and of the shifting behavior of the automatic transmission. With corresponding selection of an operating mode or driving program of the motor vehicle it is provided to transfer the at least one actuation element from the rest position into its actuation position or vice versa.

Thus it is conceivable for example that the actuation element is in rest position when a comfort mode is selected but it changes over into its actuation position as soon as a sports or dynamic mode is selected, in which the driver would like to obtain a sporty agile driving behavior and a corresponding manual control of the shifting operations of the transmission.

According to a further embodiment it is provided that the at least one actuation element is designed as pivotable and/or tiltable selector lever. There it can be more preferably provided that the actuation element can be moved into its actuation position against a resetting force made available by a spring and thereby is pivotably or tiltably mounted about a first tilting or pivot axis. This first tilting or pivot axis can substantially extend along the vehicle transverse direction so that the actuation element can be actuated for example by pulling or pushing even if the driver keeps his hand on the steering wheel.

As alternative configuration to this it is conceivable that the first tilting or pivot axis for the actuation of the actuation element also runs along the vehicle vertical axis, as a result of which an actuation of the actuation element designed as pivotable or tiltable selector lever can likewise be carried out by pulling or pushing with a hand located on the steering wheel.

According to a further embodiment of the invention it is provided that the at least one actuation element for the transferring between rest position and actuation position is pivotably or tiltably mounted about a second tilting or pivot axis. This second tilting or pivot axis runs for example in vehicle longitudinal direction, parallel to the steering column or perpendicularly to the plane of the steering wheel. There it is more preferably provided that both, the first and the second pivot axis take up a relatively large angle, approximately 90° or an angular range from approximately 70° to approximately 210°.

According to another embodiment of the invention it is provided that the at least one actuation element in its rest position comes to lie in a steering wheel component or in a steering column of the motor vehicle. Possible steering wheel components for accommodating the actuation element in its rest position are more preferably steering wheel spokes but also the steering wheel rim. A direct arrangement of the at least one actuation element on the steering wheel additionally has the advantage that the actuation element can be actuated in the customary manner independently of a steering position or a steering lock, since the relative spacing between the actuation element and the steering wheel is constant.

With an arrangement within a steering wheel component the at least one actuation element disappears from the field of vision of the driver when it assumes its rest position. This results in a particularly clearly arranged cockpit or a correspondingly clearly arranged instrument panel. The actuation element thus disappears from the field of vision of the driver and it allows a clear view of the instruments, controls and displays which seen in viewing a direction of the driver are located behind. The entire view of the vehicle interior compared to the actuation position of the actuation element appears more clearly arranged and under certain conditions more clearly structured since the actuation elements appear to be non-existent to the driver.

According to a further embodiment of the invention it is provided that the at least one actuation element in its rest position fits into the outer contour of a steering wheel component and/or in the outer contour of a steering column flush with the surface of the outer contour. In this manner, the actuation element itself makes available a closure for its reception on or in the steering component or the steering column. Insofar the arrangement of a separate closure or of a corresponding covering for an opening provided on the steering wheel which is provided to receive the actuation element can be dispensed with.

Through appropriate adaptation of the geometries of the actuation element on the one hand and its reception provided on the steering wheel component or on the steering column on the other hand a largely completely enclosed surface contour of the steering wheel or of a corresponding steering wheel component and/or of the steering column can be achieved.

According to a further embodiment of the invention it is provided that the at least one actuation element in its rest position seen in viewing direction of a vehicle occupant comes to lie behind a steering wheel component, for example of a steering wheel spoke. Thus, the at least one actuation element can be pivotably, rotatably or translatorically displaceably arranged on the steering wheel back facing away from the driver so that it merely disappears from the field of vision of the driver.

There it can be more preferably provided that the actuation element in its rest position with its actuation end radially facing to the outside, which faces away from a pivotable or rotatable suspension of the actuation element, contacts the steering wheel component or the steering wheel itself. Such a contact position of the actuation element prevents its actuation even if it should be haptically sensed by the driver.

According to a further particularly advantageous configuration of the invention it can be provided that the actuation element can be pivotably and/or translatorically moved between rest position and actuation position. Thus it can be for example provided that the actuation element starting out from its rest position performs a radial extension movement based on the extension of the steering column.

Accordingly, it can be provided that the actuation element with an arrangement directly on or in the steering wheel itself performs a displacement or translation movement in the steering wheel plane until, starting out from its rest position, it reaches the actuation position. Similarly, combined translatoric, rotatable and pivotable extension and retraction movements of the at least one actuation elements are also within the scope of the invention.

The quantity and arrangement of actuation elements for the manual selection or controlling of a vehicle transmission can vary. Thus it is conceivable for example to arrange in each case one or in each case two actuation elements on opposite spokes of a steering wheel. If for example an actuation element each is arranged on opposite steering wheel portions, these can be equipped with different but also with identical scope of function.

It is conceivable for example that an actuation element arranged in driving direction on the left is exclusively provided for downshifting a gear while the actuation element arranged in driving direction on the right located opposite is merely designed and provided for upshifting.

Deviating from this however it can also be provided that each of the actuation elements is designed both for upshifting as well as downshifting of a transmission gear for example through pulling or pushing.

Furthermore it is conceivable, on both sides or located opposite on the steering wheel to provide two actuation elements each for example in the form of a shifting rocker, wherein such a rocker switch makes available both shifting functions, both the upshifting as well as the downshifting in each case through appropriate actuation of a rocker portion. Here it can be more preferably provided that the at least one actuation element comprises two actuation levers which in their actuation position protrude from sides of a steering wheel component, for example a steering wheel spoke, facing away from each other at least in certain regions.

Transferring both actuation levers both into the rest position as well as into the actuation position preferentially takes place synchronously. It is further provided that both switches are mounted on a common second pivot or tilting axis, wherein their suspension can be pivotably or tiltably mounted about the first tilting or pivot axis.

According to a further embodiment of the invention it is provided that the at least one actuation element is coupled to a control device of the motor vehicle, which upon sensing of a safety-relevant or safety-critical operating state of the vehicle is designed in order to transfer the at least one actuation element into its rest position. This function mainly serves to transfer the actuation elements preventively, for example upon threatening risk of an accident, into their rest position so that a potential risk of injury to the vehicle occupants emanating from the actuation elements can be reduced. An impending risk of an accident can for example be determined by means of detection of a particularly high brake deceleration or transverse acceleration of the vehicle.

Alternatively or in addition to this it can also be provided to transfer the actuation elements into the rest position for example upon engaging of a reverse gear or a reverse driving mode since, particularly during parking operations, relatively large steering movements have to be performed during which actuation elements arranged in the region of the steering device could be an obstacle.

In addition to an automatic retraction and extension of the actuation elements as a function of a selected driving mode or of a driving situation it is furthermore within the scope of the invention that the driver and user can also leave the actuation elements in the rest position or transfer these into the actuation position manually and independently from this. This can take place for example with a separate actuation mechanism which can be directly arranged on the steering wheel, on the instrument panel or in the centre console, for example on the shift selector lever.

According to a further embodiment of the invention it is provided that the at least one actuation element is designed for generating an actuation signal that is visually perceptible by the vehicle occupant. To this extent the actuation element can for example make available a visually perceptible shifting point display which indicates to the driver an optimal shift timing for the manual selecting of a transmission function, for example for an incremental upshifting or downshifting.

The generation of the actuation signal can for example be signaled through illumination of a portion of the actuation element. The activation of this visually perceptible display can for example take place as a function of the selected operating mode of the motor vehicle. In an economy mode a consumption-optimized shift timing can be indicated through the illumination of the actuation element, while in a sport or dynamic mode the shifting point display implemented or integrated in the actuation element can be matched to a sportive agile driving behavior.

More preferably with such embodiments, with at least two actuation elements, of which for example one is designed for upshifting and the other for downshifting it can be provided that only one of the two, namely the actuation element to be actuated is illuminated. Here, the other actuation element remains substantially unchanged with respect to its outer appearance.

According to a further embodiment of the invention it can be provided that the at least one actuation element is designed at least for generating two different actuation signals. These different actuation signals, which preferentially should signal an actuation or non-actuation of the respective actuation elements in the process are generatable optionally as a function of the operating state of the vehicle determined or currently applicable.

There it can be provided that the actuation signals differ with respect to their visually perceptible luminous intensity and/or illumination color. For example it can be provided that an actuation element to be actuated is illuminated green while, corresponding to the operating state of the vehicle, an actuation element not requiring actuation at this point is illuminated in red. Insofar it can be provided that each of the actuation elements can be illuminated optionally red or green, while the actuation signal generated by this can also be designed variably with respect to its intensity.

According to a further embodiment of the invention an illumination element is provided which is arranged on a steering wheel or a steering wheel component of the vehicle and can be activated or deactivated as a function of a selected operating mode of the vehicle. The illumination element in this case can be arranged on or in a steering wheel rim or be integrated therein. It serves for the visualization of a selected driving mode. Thus it is for example provided to activate the illumination element when the driver of the vehicle selects a sport or dynamic mode.

There it can be more preferably provided that individual illumination elements are arranged in one or a plurality of positions on the steering wheel rim or on the steering wheel spokes. Especially in darkness this makes possible a better visual detection of the steering wheel position. In addition, diverse different vehicle modes can be more easily and more intuitively perceived by the user through the illumination.

Activation or deactivation of the illumination element or of the illumination elements can be effected in combination with but also independently of an adjusting movement of the actuation elements. In addition, such steering wheels in the sense of the present invention are steering wheels which have no actuation elements arranged in the region of a steering wheel, at least have an illumination element provided for the visualization of the respective operating mode.

According to a further embodiment of the invention, a method is provided for actuating an automatic transmission of a motor vehicle, which can be operated in at least two different operating modes and which on a steering device comprises at least one actuation element. This actuation element is provided for the manual selecting or activating of an operating state of the vehicle or its transmission. The method is characterized in that the at least one actuation element as a function of the operating mode of the motor vehicle is optionally transferred into a rest position or into an actuation position, wherein the actuation element can be exclusively actuated in the actuation position for selecting or activating a transmission and/or vehicle function.

There it can be provided that the at least one actuation element is transferred into the rest position as a result of a sensory detection of a safety-relevant operating state or of a predetermined operating state for example when engaging a reverse driving mode, in which with regard to its mode of operation it is deactivated.

### BRIEF DESCRIPTION OF THE DRAWINGS

The present invention will hereinafter be described in conjunction with the following drawing figures, wherein like numerals denote like elements, and:

FIG. 1 is a schematic representation of a steering wheel with a total of two actuation elements in rest position arranged thereon;

FIG. 2 is the steering wheel according to FIG. 1 with the actuation elements in actuation position;

FIG. 3 is a further embodiment of a steering wheel with a total of four actuation elements in rest position;

FIG. 4 is the steering wheel according to FIG. 3 with its actuation elements in actuation position;

FIG. 5 is a further embodiment of the invention with visual displays integrated in actuation elements; and

FIG. 6 is a further embodiment of the invention with an illumination element arranged on the steering wheel rim.

### DETAILED DESCRIPTION

The following detailed description is merely exemplary in nature and is not intended to limit application and uses. Furthermore, there is no intention to be bound by any theory presented in the preceding background or summary or the following detailed description

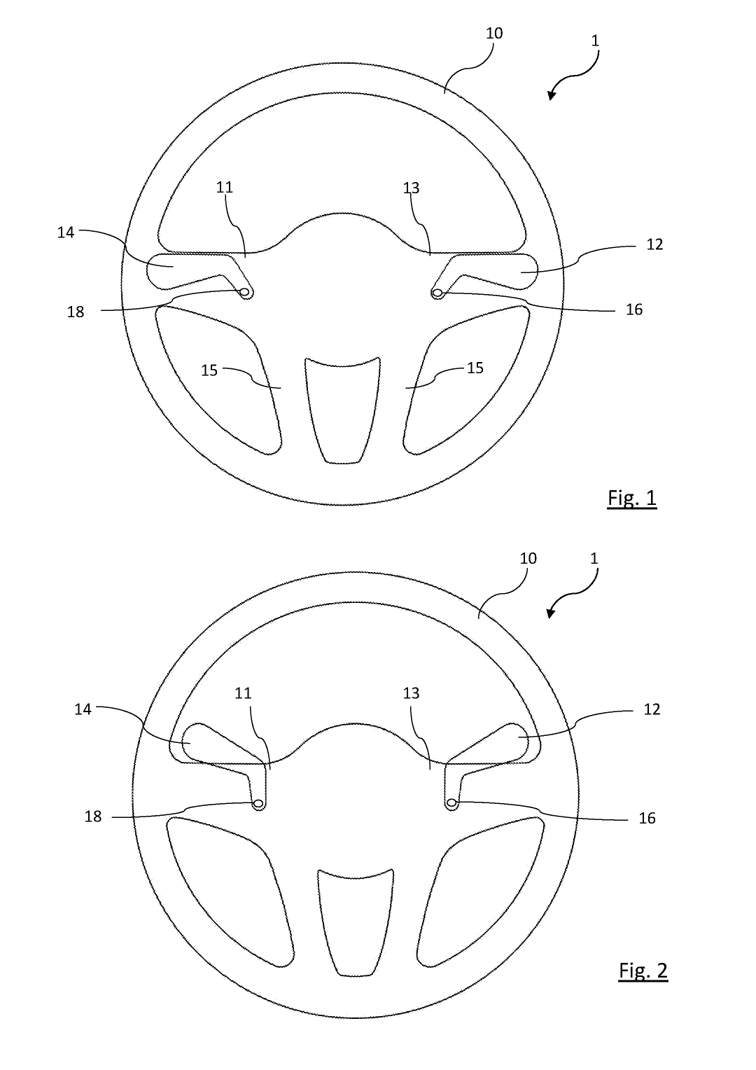

The steering wheel 1 shown in the FIG. 1 and FIG. 2 comprises a steering wheel rim 10 and a quantity of steering wheel spokes 11, 13, 15 wherein in the representation according to the FIG. 1 and FIG. 2, which reflects a basic position of the steering wheel, the two steering wheel spokes 11, 13 extend radially to the outside in horizontal direction. Based on the steering axis, these are arranged located diametrically opposite each other.

The further steering wheel spoke 15 by contrast is divided in two. It extends in the representation according to FIG. 1 and FIG. 2 substantially in vertical direction. The steering wheel construction and the steering wheel geometry merely play a subordinate role for the present invention. The arrangement and the mode of operation of the actuation elements 12, 14 according to the invention can be transferred to almost any popular steering wheel geometry whatsoever.

In the exemplary embodiment according to the FIG. 1 and FIG. 2 an actuation element 12, 14 each designed in the manner of an actuation lever is pivotably arranged on the steering wheel spokes 11, 13 each. The respective pivot or tilting axes 16, 18 in this case run substantially perpendicularly to the steering wheel plane, i.e., substantially parallel to the longitudinal extension of the steering column.

In the configuration shown in FIG. 1, which represents the rest position of the actuation elements, both actuation levers 12, 14 are located completely behind or within the steering wheel spokes 11, 13, while in the actuation position shown in FIG. 2 both actuation elements 12, 14 are pivoted up and thus protrude over the outer contour of the steering wheel spokes 11, 13 at least in certain regions. In this actuation position the actuation lever can be actuated for example by exerting a pulling or pushing force substantially directed perpendicularly to the steering wheel plane.

With the actuation of the actuation levers 12, 14 it can be provided for example that the entire lever 12, 14 is pivoted or tilted about a first tilting or pivot axis. This tilting or pivot axis preferentially extends in vehicle transverse direction that is in horizontal direction based on the representation of the FIG. 1 and FIG. 2. However, it can also be alternatively provided that this tilting or pivot axis substantially extends in the direction of the vehicle vertical axis which, based on the basic state of the steering wheel 1 shown in the FIG. 1 and FIG. 2, runs in vertical direction.

The assignment of the actuation elements 12, 14 in this case can be configured variously. Thus it is conceivable for example that by exerting a pulling force on the actuation element 14 a lower gear of the transmission is selected while by actuating the other actuation lever 12 the transmission is upshifted by a gear.

Alternatively to this it can be provided that both actuation levers 12, 14 are equipped with an identical scope of operation, so that for example by pulling or pushing one of the actuation levers 12, 14 the next higher or next lower gear is selected. With such a configuration the actuation levers 12, 14 would be transferable out of a rest position into different actuation positions through pulling or pressure effect, in accordance with which a gear predetermined by the user is selected or engaged.

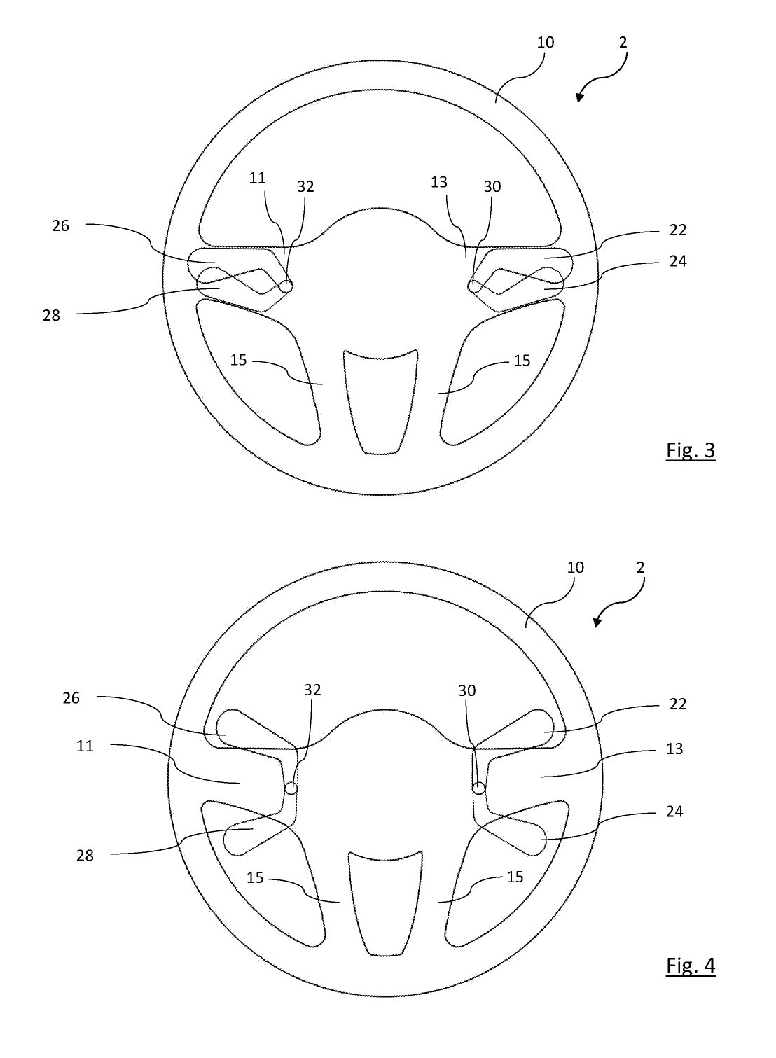

The configuration of the steering wheel according to the FIG. 3 and FIG. 4 differs from that of the FIG. 1 and FIG. 2 in that on each steering wheel spoke 11, 13 of the steering wheel 2 two actuation elements 22, 24 and 26, 28 each designed as actuation levers are pivotably arranged. The actuation levers 26, 28 pivotably arranged about a common pivot axis 32 on the steering wheel spoke 11 can be transferred from a rest position shown in FIG. 3, in which none of the levers 26, 28 can be actuated, into the actuation position shown in FIG. 4. The same applies correspondingly to the actuation levers 22, 24 mounted located opposite on the steering wheel spoke 13 on the corresponding tilting or pivot axis 30.

The actuation levers 26, 28, which are mounted on a common axis 32, can either be actuated completely independently of each other or be designed as a kind or rocker switch or shifting rocker. Consequently an actuation of the shifting lever 26 can cause a corresponding countermovement of the opposite actuation lever 28 protruding over the bottom of the steering wheel spoke 11 at least in certain regions. The individual actuation levers 22, 24, 26, 28 however can be completely decoupled from one another mechanically.

With respect to their operating mode the actuation levers 22, 24 and 26, 28 arranged by pairs can initiate opposing shifting operations. While the actuation of the lever 22 for example results in an upshifting of the transmission, an opposing shifting operation can be initiated through the actuation of the opposite shifting lever 24.

The two opposing shifting levers 26, 28 in this case can be equipped with an identical scope of operation but also with one that deviates from the operating mode describe above. Furthermore it is conceivable that the shifting rocker formed by the shifting levers 22, 24 is exclusively provided for the manual upshifting or downshifting of a transmission gear and are designed for this purpose, while the other shifting rocker formed by the actuation levers 26, 28 is designed for selecting different driving modes, for example a comfort mode, a sports mode or an economy mode.

Retracting and extending of all shifting levers 12, 14, 22, 24, 26, 28, 34, 36 shown in the Figures can either be triggered through actuation of a further actuation element, which is directly arranged on the steering wheel or elsewhere in the vehicle interior.

Advantageously, extending and folding-in the actuation levers 12, 14, 22, 24, 26, 28, 34, 36 largely takes place automatically. If for example the driver desires a sportive agile or dynamic driving behavior, which said driver can signal by selecting a corresponding driving mode or for example through kickdown-like depressing of the accelerator pedal, it can be provided to transfer all actuation levers 12, 14, 22, 24, 26, 28, 34, 36 into the actuation positions shown in the FIG. 2 or FIG. 4.

Conversely, transferring all actuation levers 12, 14, 22, 24, 26, 28, 34, 36 into the rest position indicated in the FIG. 1 and FIG. 2 is provided as soon as the vehicle is operated in a parking mode for example during parking or if a reverse driving mode or reverse gear is engaged.

In addition to this it can be provided that all actuation levers 12, 14, 22, 24, 26, 28, 34, 36 are transferred into their rest position immediately upon or after detection of a critical driving situation, so that no or only a reduced risk of injury to the vehicle occupants emanates from the actuation levers 12, 14, 22, 24, 26, 28, 34, 36.

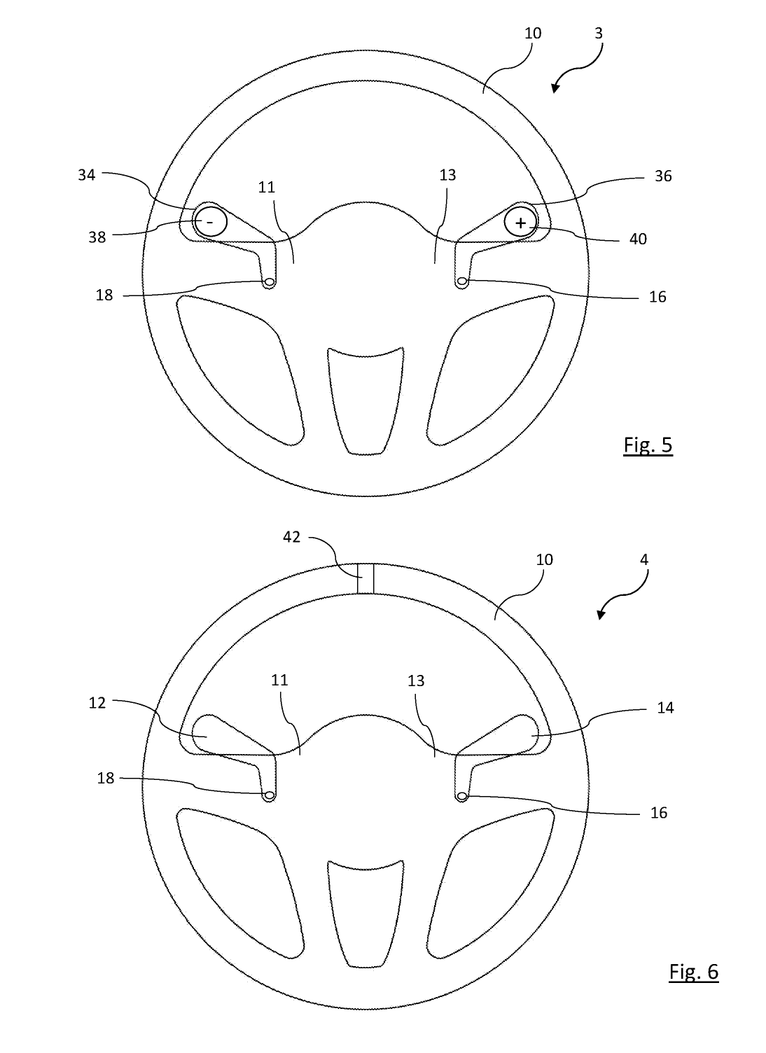

FIG. 5 shows a further embodiment of a steering wheel based on the configuration of the FIG. 1 and FIG. 2 with actuation levers 34, 36 pivotably or foldably arranged thereon. The two actuation levers 34, 36 in this case are provided with a fixed predetermined scope of operation. The actuation lever 34 is provided for selecting a lower transmission gear while the actuation lever 36 is designed for upshifting, as is also indicated by the signs “− and +”.

Both actuation levers 34, 36 at their free end portion to be actuated by vehicle occupants comprise a display or an illuminated field 38, 40, by means of which a visually perceptible actuation signal is generated if required, so that a gear change can be suggested to the driver of the vehicle.

The signaling of a gear change to be manually performed by the driver in this case can be adapted as a function of the respective prevailing driving mode. If for example an economy driving mode is selected, it is provided to generate the actuation signals with respect to particularly fuel-saving and consumption-optimized shifting operations. In a sports or dynamic mode by contrast it can be provided to activate the actuation signals in a performance-optimized manner.

The displays 38, 40 can be designed as illumination fields which are illuminated in one color or as displays which are illuminated in two colors or multiple colors. The illumination fields 38, 40 can also generate different light intensities by means of which an actuation to be performed can be signaled.

Thus it can be provided for example that the displays 38, 40 of the actuation elements 34, 36 are coupled to an instrument panel illumination so that for example both actuation elements when switching on the headlights are illuminated relatively little or dimmed. As soon as a control unit generates an actuation signal the corresponding illumination field 38 or 40 is illuminated.

In addition or alternatively to this it can also be provided that both illumination fields or displays 38, 40 can optionally be illuminated in different signal colors, for example green or red. Here, a green illumination can signal an actuation while a red illumination signals to the driver not to actuate said red illuminated actuation element at this point in time.

FIG. 6 finally shows a fourth embodiment of the invention, namely a steering wheel 4 with an illumination element 42 integrated in the steering wheel rim 10. The illumination element 42 is more preferably provided for the visualization of an operating mode of the vehicle selected by the driver. When selecting a sports or dynamic program the illumination element 42 is activated, while it is deactivated in a comfort mode or is illuminated in a color deviating from that of the sports mode.

The activation of the illumination elements can take place in combination with and coupled to an adjusting movement of the actuation elements 12, 14 between rest position and actuation position. However, it can also be alternatively provided to activate the illumination independently of the respective position or adjusting movement of the actuation elements.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A device for actuation of an automatic transmission of a motor vehicle, comprising:
a steering device; and
an actuation element arranged on the steering device that is configured for manually selecting of an operating state,
wherein the actuation element is configured for optionally transferring into a rest position and into an actuation position, and
wherein the actuation element can be actuated exclusively in the actuation position for selecting a vehicle function.

2. The device according to claim 1, wherein the actuation element is configured for transferring into the rest position as a function of a selected operating mode of the motor vehicle.

3. The device according to claim 1, wherein the actuation element is a selector lever.

4. The device according to claim 3, wherein the actuation element in the actuation position is mounted about a first axis against a resetting force.

5. The device according to claim 1, wherein the actuation element is configured for transferring between the rest position and the actuation position and mounted about a second axis.

6. The device according to claim 5, wherein the second pivot axis substantially runs parallel to a longitudinal extension of a steering column of the motor vehicle.

7. The device according to claim 1, wherein the actuation element in the rest position comes to lie in a steering wheel component.

8. The device according to claim 1, wherein the actuation element in the rest position with a surface of an outer contour is inserted flush into the outer contour of a steering wheel component.

9. The device according to claim 1, wherein the actuation element is configured for translatoric movement between the rest position and the actuation position.

10. The device according to claim 1, wherein the actuation element comprises two actuation levers that in the actuation position protrudes from sides of a steering wheel component facing away from each other.

11. The device according to claim 1, wherein the actuation element is coupled to a control device which upon sensing of the operating state of the motor vehicle is configured to transfer the actuation element into the rest position.

12. The device according to claim 1, wherein the actuation element is configured to generate a visually perceptible actuation signal.

13. The device according claim 1, wherein the actuation element is configured to generate at least two different actuation signals which can be optionally generated as a function of the operating state of the motor vehicle.

14. The device according to claim 1, further comprising an illumination element arranged on a steering wheel component that is configured for activation as a function of a selected operating mode of the motor vehicle.

15. A method for actuating an automatic transmission of a motor vehicle that is configured to operate in an operating mode and on which a steering device comprises an actuation element, that is configured for manual selection of an operating state, comprising:
determining the operating mode of the motor vehicle;
transferring the actuation element into a rest position or into an actuation position as a function of the operating mode of the motor vehicle; and
limiting actuation of the actuation element to the actuation position for selecting a vehicle function.

16. The method according to claim 15, further comprising transferring the actuation element into the rest position as a consequence of a detection of a safety-relevant operating state.

17. The method according to claim 15, wherein the vehicle function is a transmission function.

18. The device according to claim 1, wherein the vehicle function is a transmission function.
